(19) United States
(12) Patent Application Publication
(10) Pub. No.: US 2022/0143963 A1
(43) Pub. Date: May 12, 2022

(54) ADHESIVE BACKED HYDROLYSIS-RESISTANT WINDOW FILM

(71) Applicant: GARWARE HI-TECH FILMS LIMITED, Mumbai (IN)

(72) Inventors: Shashikant Bhalchandra GARWARE, Aurangabad (IN); Monika Shashikant GARWARE, Aurangabad (IN)

(73) Assignee: GARWARE HI-TECH FILMS LIMITED, Mumbai (IN)

(21) Appl. No.: 17/509,397

(22) Filed: Oct. 25, 2021

(30) Foreign Application Priority Data
Nov. 6, 2020 (IN) 202021048603

(51) Int. Cl. B32B 27/36; B32B 27/08; B32B 27/20

(52) U.S. Cl. CPC B32B 27/36; B32B 27/08; B32B 27/20; B32B 2307/584; B32B 2307/42; B32B 2264/102; B32B 2255/26; B32B 2255/10; B32B 2307/71

(57) ABSTRACT

The present disclosure relates to an adhesive backed hydrolysis-resistant window film. The window film comprises at least one hydrolysis resistant polyethylene terephthalate (PET) first substrate layer having a first operative surface and a second operative surface, a NIR absorbing scratch resistant coat having near-infrared absorbing nano-particles disposed on the first operative surface, optionally at least one hydrolysis resistant polyethylene terephthalate (PET) second substrate layer having a third operative surface and a fourth operative surface, a first adhesive layer disposed on the second operative surface and optionally on the fourth operative surface, optionally a second adhesive layer containing infrared absorbing nano-particles disposed between the second operative surface and the third operative surface, at least one release liner disposed on the first adhesive layer. The film of the present disclosure has improved mechanical strength, weather resistance level, long-term UV stability, and hydrolysis resistance.

### FIELD

The present disclosure relates to an adhesive backed hydrolysis-resistant window film.

### Definitions

As used in the present disclosure, the following terms are generally intended to have the meaning as set forth below, except to the extent that the context in which they are used indicates otherwise.

Adhesion promoter: The term “adhesion promoter” refers to an additive or as a primer to promote the adhesion of coatings, inks, or adhesives to the substrate of interest.

Release liner: The term “release liner” refers to a thin film of material pulled away from the sticky side of the adhesive side of a product.

Slip additives: The term “slip additives” refers to the additives that are added to reduce the surface coefficient of friction of polymers and are used to enhance either processing or end applications.

Dimensionally stable: The term “dimensionally stable” refers to polymeric protection installed on the exterior or interior surface of automotive windshield/window and architectural glasses that maintains its original dimensions subjected to changes in temperature and humidity.

HALS: The term “HALS” refers to Hindered-Amine Light Stabilizers. Hindered amines are chemical compounds containing an amine functional group surrounded by a crowded steric environment. Hindered amines can be used as stabilizers against light-induced polymer degradation.

NIR blocking film: The term “NIR blocking film” refers to a near-infrared blocking film that has been coated to block both harmful UV radiation in the range of 780 nm to 2500 nm.

### BACKGROUND

The background information hereinbelow relates to the present disclosure but is not necessarily prior art.

Adhesive backed polymeric window films are optically clear and distortion-free. Adhesive backed polymeric window films consist of scratch-resistant coating, a layer of bi-axially oriented polyester film combined with a thick layer of strong adhesive, and a transparent release sheet. Polyester film has an excellent optical clarity and has better mechanical properties. These films are installed on the interior or exterior surfaces of pre-cleaned window glasses.

The purpose of applying adhesive backed polymeric window films to a glass substrate is for the modification of the breakage characteristics of the glass pane to which it has been applied. The films can be used on external and internal glass panes of buildings where there is a possibility for injury from broken glass.

Further, the adhesive backed polymeric window films are applied on the glass for solar radiation control, the film is to modify the spectrophotometric properties of the glass substrate and modify its breakage characteristics. These films are preferred at places where solar radiation control is required. The polyester films are prone to hydrolysis, after prolonged exposure to natural weathering conditions it loses its mechanical properties. There is a need to improve the hydrolysis resistance of adhesive backed window films to provide extended retention of mechanical properties.

When a thicker grade of PET films are used in product design, it provides safety against dangerous glass splinters which may be generated during glass breakage. These adhesive backed films provide resistance to human attack, explosive pressure, and ballistic attack and modify the shatter pattern, impact behaviour, and resistance to attempted human penetration, including tools such as hammers, screwdrivers, stones, and the like to provide a higher level of security.

Several attempts have been carried out to provide films for protecting the automotive and architectural glass from damage. However, the polyester film used for making window films has certain disadvantages, such as being non-resistant to hydrolysis, not UV stabilized, turns yellow after prolonged exposure to direct sunlight. Polyesters undergo hydrolytic bond cleavage when exposed to moisture results to loss of molecular weight has effect on mechanical properties.

Further, prolonged exposure to direct sunlight, the window film laminated automotive and architectural glasses result in loss of transparency of the film. Degradation of the polymeric window films reduces visibility through the glass and loss of mechanical properties. It is well known that moisture ingress into the polymeric protective film, accelerates the degradation. The moisture in the adhesive reduces the bond between the film and glass. Carboxyl end groups present in the polymeric window film are sensitive to humidity. Hydrolysis reactions can change the performance properties and chemical structure of the polymeric window film.

Therefore, there is felt a need to provide adhesive backed hydrolysis-resistant window film that mitigates the drawbacks mentioned hereinabove.

### Objects

Some of the objects of the present disclosure, which at least one embodiment herein satisfies, are as follows.

It is an object of the present disclosure to ameliorate one or more problems of the prior art or to at least provide a useful alternative.

Another object of the present disclosure is to provide an adhesive backed polymeric window film with improved hydrolysis resistance for architectural and automotive application.

Still another object of the present disclosure is to provide an adhesive backed polymeric window film with improved hydrolysis resistance property for architectural and automotive application.

Yet another object of the present disclosure is to provide an adhesive backed polymeric window film with improved hydrolysis resistance and silicon hard coat for exterior installation for architectural and automotive application.

Another object of the present disclosure is to provide an adhesive backed polymeric window film with improved hydrolysis resistance property produced in combination with UV stabilized dip dyed film for architectural and automotive application.

Another object of the present disclosure is to provide an adhesive backed polymeric window film with improved hydrolysis resistance property produced in combination with UV stabilized hydrolysis resistant dip dyed film for architectural and automotive application.

Still another object of the present disclosure is to provide an adhesive backed polymeric window film produced by using hydrolysis resistant PET film for automotive front windshield application.

Other objects and advantages of the present disclosure will be more apparent from the following description, which is not intended to limit the scope of the present disclosure.

### SUMMARY

The present disclosure relates to an adhesive backed hydrolysis-resistant window film for architectural and automobile application.

The adhesive backed hydrolysis-resistant window film comprises at least one hydrolysis resistant polyethylene terephthalate (PET) first substrate layer having a first operative surface and a second operative surface, a NIR absorbing scratch resistant coat having near-infrared absorbing nano-particles disposed of on the first operative surface, optionally at least one hydrolysis resistant polyethylene terephthalate (PET) second substrate layer having a third operative surface and a fourth operative surface, a first adhesive layer disposed on the second operative surface and optionally on the fourth operative surface, optionally a second adhesive layer containing infrared absorbing nano-particles disposed between the second operative surface and the third operative surface, at least one release liner disposed on the first adhesive layer. The adhesive backed hydrolysis-resistant window film optionally comprises an adhesion promoter layer disposed above the first adhesive layer.

### DETAILED DESCRIPTION

Embodiments are provided so as to thoroughly and fully convey the scope of the present disclosure to the person skilled in the art. Numerous details are set forth, relating to specific components and methods to provide a complete understanding of embodiments of the present disclosure. It will be apparent to the person skilled in the art that the details provided in the embodiments should not be construed to limit the scope of the present disclosure. In some embodiments, known processes or well-known apparatus or structures, and well known techniques are not described in detail.

The terminology used, in the present disclosure, is only for the purpose of explaining a particular embodiment and such terminology shall not be considered to limit the scope of the present disclosure. As used in the present disclosure, the forms “a,” “an,” and “the” may be intended to include the plural forms as well, unless the context clearly suggests otherwise. The terms “comprises,” “comprising,” “including,” and “having,” are open ended transitional phrases and therefore specify the presence of stated features, integers, steps, operations, elements, modules, units, and/or components, but do not forbid the presence or addition of one or more other features, integers, steps, operations, elements, components, and/or groups thereof. The particular order of steps disclosed in the method and process of the present disclosure are not to be construed as necessarily requiring their performance as described or illustrated. It is also to be understood that additional or alternative steps may be employed.

The terms first, second, third, etc., should not be construed to limit the scope of the present disclosure as the aforementioned terms may be only used to distinguish one element, component, region, layer or section from another component, region, layer or section. Terms such as first, second, third, etc., when used herein do not imply a specific sequence or order unless clearly suggested by the present disclosure.

Several attempts have been carried out to provide films for protecting the automotive and architectural glass from damage. However, the polyester film used for making window films has certain disadvantages, such as being non-resistant to hydrolysis, not UV stabilized, turns yellow after prolonged exposure to direct sunlight. These films lose mechanical properties after prolonged exposure to natural weather conditions and sunlight, get easily scratched, and have inferior optical clarity because of mounting adhesive distortion.

Therefore, the present disclosure provides adhesive backed hydrolysis-resistant window film, which overcomes the drawbacks associated with the conventional films.

The present disclosure relates to an adhesive backed hydrolysis-resistant window film for architectural and automobile applications.

In an embodiment, the adhesive backed hydrolysis-resistant window film comprises at least one hydrolysis resistant polyethylene terephthalate (PET) first substrate layer having a first operative surface and a second operative surface, a NIR absorbing scratch resistant coat having near-infrared absorbing nano-particles disposed on the first operative surface, optionally at least one hydrolysis resistant polyethylene terephthalate (PET) second substrate layer having a third operative surface and a fourth operative surface, a first adhesive layer disposed on the second operative surface and optionally on the fourth operative surface, optionally a second adhesive layer containing infrared absorbing nano-particles disposed between the second operative surface and the third operative surface, at least one release liner disposed on the first adhesive layer.

In an embodiment, the adhesive backed hydrolysis-resistant window film comprises optionally an adhesion promoter layer disposed above the first adhesive layer.

In an embodiment, the hydrolysis resistant polyethylene terephthalate first substrate layer is UV stabilized.

In an embodiment, the UV stabilized hydrolysis resistant polyethylene terephthalate first substrate layer comprises at least one hydrolysis resistant stabilizer.

In an embodiment, the hydrolysis resistant polyethylene terephthalate (PET) second substrate is at least one selected from a UV stabilized dip dyed polyethylene terephthalate (PET) substrate and a dip dyed polyethylene terephthalate (PET) substrate.

In an embodiment, the first substrate layer is co-extruded with the second substrate layer.

In another embodiment, the hydrolysis resistant PET substrate layer can be co-extruded with the hydrolysis resistant PET substrate layer. The co-extruded hydrolysis resistant PET substrate layer can be multi-layer biaxially oriented polyester film comprising a primary polyester substrate layer and a secondary polyester substrate layer. In still another embodiment, the primary polyester layer comprises a hydrolysis resistant additive and the secondary polyester layer comprises UV absorber and the hydrolysis resistant additive which may face the hard coat side of the adhesive backed hydrolysis-resistant window film.

In an embodiment, the co-extruded PET substrate layer used in the adhesive backed hydrolysis-resistant window film can be formed by co-extruding the UV stabilized hydrolysis resistance polyethylene terephthalate substrate layer and the hydrolysis resistant polyethylene terephthalate substrate layer. In another embodiment, the hydrolysis resistant PET substrate layer can be formed by co-extruding two UV stabilized hydrolysis resistance polyethylene terephthalate substrate layers.

In an embodiment, the infrared absorbing nanoparticle is a metal composite and is at least one selected from the group consisting of Cesium tungsten oxide (CTO) nanoparticles, hexaboride nanoparticles(CTO), antimony tin oxide (ATO) nanoparticles, and indium tin oxide (ITO) nanoparticles.

In one embodiment, the infrared absorbing nanoparticles comprising composite tungsten oxide expressed by the general formula MₓW_{y}O_{z} where M is at least one metal selected from the group consisting of alkali metals, alkali earth metals, a rare earth element, and one or more elements selected from the group consisting of Mg, Zr, Cr, Mn, Fe, Ru, Co, Rh, Ir, Ni, Pd, Pt, Cu, Ag, Au, Zn, Cd, Al, Ga, In, TI, Si, Ge, Sn, Pb, Sb, B, F, P, S, Se, Br, Te, Ti, Nb, V, Mo, Ta, Re, Be, Hf, Os, and Bi; W is tungsten, O oxygen, wherein x is ≥0.001, y is ≤1 and z is in the range of 2.2 to 3.0; hexaborides, antimony tin oxide (ATO), and indium tin oxide (ITO) incorporated in the adhesive layer. The tungsten oxide composite is doped with metal (M) that improves infrared absorption characteristics and becomes an effective infrared absorber. Typically, the adhesive layer is sandwiched between the two hydrolysis resistant PET substrate layers to obtain a filmed structure for shielding against infrared radiations from 700 nm to 2500 nm. The film structure has a very low haze value.

The diameter of the nanoparticles functioning to screen/shield the infrared radiations can be in the range from 1 nm to 500 nm, preferably below 100 nm. In one embodiment the nano-particles incorporated in the adhesive layer of the window film have lower particle size to minimize the light scattering effect.

It is observed that more effective infrared absorbing material can be produced by controlling oxygen and adding M (metal) to generate nano-particles. The doped tungsten oxide nanoparticles and the nanoparticles of tungsten oxide composite having a hexagonal or monoclinic crystal structure. The nano-particles for shielding against infrared radiation contain nano-particles of tungsten oxide having a hexagonal or monoclinic crystal structure, the nano-particles having these crystal structures are chemically stable and have favourable optical characteristics. As the nano-particles of tungsten oxide composite are used for shielding against infra-red radiation, it is possible to obtain the adhesive backed hydrolysis-resistant window film structure for shielding against infra-red radiation with excellent stability and infra-red radiation blocking characteristics by using the nano-particles as the ones for shielding against solar radiation.

In one embodiment, the scratch resistant coat is at least one selected from the group consisting of a silicon based UV hard coating and an acrylic based UV hard coat. The scratch resistant coat improves weatherability, reduces surface damage from scratching, and is disposed on the first operative surface of the hydrolysis resistant polyethylene terephthalate (PET) first substrate layer.

In an embodiment, the first adhesive layer and the second adhesive layer are independently selected from the group consisting of polyurethane adhesives, silylated polyurethane adhesives, and pressure sensitive adhesives. In an exemplary embodiment, the adhesive layer is a thermosetting adhesive layer.

In an embodiment, the adhesion promoter layer is selected from polyurethanes and acrylates.

The adhesion promoter layer can act as a primer. The primer is selected from an acrylic base and a polyurethane base having a good bond with the polyester film and acrylic pressure sensitive adhesive. The primer layer is very thin, typically in nanometers.

The adhesive can be acrylate monomers such as esters of acrylic and/or methacrylic acids. In one embodiment, the acrylate monomer is an ester of methacrylic acid. A large number of useful monomers, both monofunctional and polyfunctional, are commercially available. The selection of the monomer or mixtures of monomers may depend on the intended use of the adhesive, substrates to be bonded, desired viscosity. Suitable acrylic monomer includes methyl methacrylate (MMA), methyl acrylate (MA), ethyl methacrylate, ethyl acrylate, hydroxyethyl acrylate (HEA), hydroxyethyl methacrylate (HEMA), hydroxypropyl acrylate, 4-hydroxybutyl acrylate, isobutyl acrylate, tert-butyl acrylate, n-octyl acrylate, isooctyl acrylate, isononyl acrylate, lauryl acrylate, stearyl acrylate, isostearyl acrylate, isonorbornyl acrylate, tetrahydrofurfuryl acrylate, methoxyethyl acrylate, and methoxypolyethylene glycol acrylate.

The thickness of the acrylic pressure sensitive (PS) adhesive can be in the range of 5 to 24 grams per meter square, typically 7±2 g/m². Acrylic PS adhesive can be formulated by using a mixture of an acrylic adhesive; a cross linker, such as isocyanate; metal chelate; solvents such as toluene, methyl ethyl ketone (MEK), ethyl acetate isopropyl alcohol, UV absorbers, antioxidant, and HALS stabilizer. The PS Adhesive formulation is applied to the second operative surface of the hydrolysis resistant polyester substrate layer using a gravure roll coater or a die (dye) coater in desired wet coating thickness to obtain a film. Further, the so obtained film is passed through a hot air circulating oven. The adhesive layer is protected with a silicon release liner.

In one embodiment, the polyurethane adhesive forming resin composition of the present disclosure is produced by trans-esterification of dialkyl ester of terephthalic acid, preferably dimethyl terephthalate, isophthalic acid, and aliphatic dicarboxylic acid such as sebacic acid with monoethylene glycol, neopentyl glycol, 2-methyl-1,3-propanediol. Trans-esterification is carried at an elevated temperature ranging from 180 to 250° C. Methanol and water are the by-products of the trans-esterification reaction which is removed by distillation from the reaction mixture. A trans-esterification catalyst is used to accelerate the reaction rate. In another embodiment, the polyurethane adhesive forming resin composition of the present disclosure is produced by direct esterification of terephthalic acid, sebacic acid, isophthalic acid, and ethylene glycol. The by-product of the reaction is water, which is distilled off from the reaction mixture. The reaction mixture is heated above the boiling point of the glycol mixture used in the trans-esterification process (monoethylene glycol, neopentyl glycol, 2-methyl-1, 3-propanediol) to remove the excess quantity of glycol. The intrinsic viscosity of the polymer is maintained in between 0.35 dUg to 1.0 dUg. The polyester polyol may have an average molecular weight in the range of 500 to 30,000; preferably 6000 to 20,000. The number of hydroxyl groups in the polyester polyol may be in the range of 1 to 20, more, preferably 2 to 4, depending on the intended application of the resulting polyurethane.

In one embodiment, the polyester thus produced has an intrinsic viscosity in the range of 0.4 dL/gm to 0.8 dL/gm, preferably, the intrinsic viscosity of the polyester, wherein the polyester solution is prepared in the mixture of phenol and tetrachloroethane at 25° C., is in the range of 0.5 dL/gm to 0.7 dUg.

The polyester polyol may be cross-linked with at least one isocyanate terminated co-reactant to improve its durability, hardness, cohesive strength, and adhesion to substrate. In one embodiment, the isocyanate-functional component may contain at least one isocyanate-functional group, poly-isocyanates such as urea, biurets, allophanates, dimers, and trimers of poly-isocyanates, and mixtures thereof. Poly-isocyanates have at least two isocyanate-functional groups and provide urethane linkages when reacted with the preferred hydroxy-functional components. Examples of the suitable organic di-isocyanates include 1,4-tetramethylene di-isocyanate, 1,6-hexamethylene di-isocyanate, 2,2,4-trimethyl-1,6-hexamethylene di-isocyanate, 1,12-dodecamethylene di-isocyanate, cyclohexane-1,3- and -1,4-diisocyanate, 1-isocyanato-2-isocyanatomethyl cyclopentane, 1-isocyanato-3-isocyanatome-thyl-3,5,5-trimethyl-cyclohexane (isophorone di-isocyanate or IPDI), bis-(4-isocyanatocyclohexyl)-methane, 2,4′-dicyclohexyl-methane di-isocyanate, 1,3- and 1,4-bis-(isocyanatomethyl)-cyclohexane, bis-(4-isocyanato-3-methyl-cyclohexyl)-methane, 1-isocyanato-1-methyl-4(3)-isocyanatomethyl cyclohexane, 2,4- and/or 2,6-hexahydrotoluylene di-isocyanate, 1,3- and/or 1,4-phenylene di-isocyanate, 2,4- and/or 2,6-toluylene di-isocyanate, 2,4- and/or 4,4′-diphenyl-methane di-isocyanate, 1,5-diisocyanato naphthalene and mixtures thereof. Some commercially available poly-isocyanates include the DESMODUR and MONDUR series from Covestro; and the PAPI series from Dow Plastics, a business group of the Dow Chemical Company. Preferred tri-isocyanates include those available from Covestro under the trade name DESMODUR N-3300, DESMODUR N-3390, and MONDUR 489. Aliphatic isocyanate is used predominately in coating applications because they produce polyurethanes with excellent UV resistance and exterior durability in comparison to aromatic isocyanates. The aliphatic isocyanates are slower in their reaction with polyols. The polyester polyols component is reacted with an isocyanate-functional component during the formation of the polyurethane-based primer coating and adhesive composition of the present application.

In one embodiment of the present disclosure, the hydrolysis resistant PET substrate first substrate layer, hydrolysis resistant polyethylene terephthalate (PET) second substrate and the UV stabilized hydrolysis resistance polyethylene terephthalate first substrate layer comprises at least one hydrolysis resistant stabilizer selected from the group consisting of carbodiimide compound and glycidyl ester of branched monocarboxylic acid.

The hydrolysis resistant stabilizer used in the hydrolysis resistant PET substrate layer and the UV stabilized hydrolysis resistance polyethylene terephthalate substrate layer of the present disclosure acts as an end-group capper for the polyester by reacting with the carboxyl end-groups of the polyester. Carboxyl end-groups are primarily responsible for the hydrolytic degradation of polyesters, including polyethylene terephthalate. In one embodiment of the present disclosure, the hydrolysis resistant stabilizer(s) used in the present disclosure comprises at least one glycidyl ester of a branched monocarboxylic acid and at least one carbodiimide compound. The glycidyl group of the hydrolysis resistant stabilizer reacts rapidly with the end-groups of the polyester at elevated temperatures.

The polymer (polyethylene terephthalate polyester) further contains a carbodiimide compound, which is used to seal the carboxyl end group that remains in the polymer. The carbodiimide compounds can be selected from the group consisting of dicyclohexyl carbodiimide, diisopropyl carbodiimide, di-isobutyl carbodiimide, dioctyl carbodiimide, octyl decyl carbodiimide, dibenzyl carbodiimide, diphenyl carbodiimide, N-benzyl-N-phenyl carbodiimide, di-p-toluyl carbodiimide, preferably bis(2,6 di isopropyl phenyl)carbodiimide and 2,6,2′, 6′-tetra isopropyl diphenyl carbodiimide. The carbodiimide compound used in the present disclosure has an equivalent weight in the range of 100-1000 and the amount of carbodiimide compound ranges from 1 to 10 parts by weight of the polyester film. The hydrolysis resistance of the PET substrate layer depends on the quantity/amount of the carbodiimide compound.

In an embodiment, the carbon atom counts of the glycidyl ester of branched monocarboxylic acid are in the range of 5 to 50 carbon atoms.

In an embodiment, the UV stabilized hydrolysis resistance polyethylene terephthalate layer comprises at least one UV absorber selected from the group consisting of 2-hydroxybenzophenones, 2-hydroxybenzotriazoles, organonickel compounds, salicylic esters, cinnamic ester derivatives, resorcinol monobenzoates, oxanilides, hydroxybenzoic esters, benzoxazinones, sterically hindered amines, and triazines, preferably 2-hydroxybenzotriazoles, benzoxazinones, hydroxyphenyltriazine, and hydroxyphenyl-benzotriazole triazines.

UV absorbers are chemical compounds that can intervene in the physical and chemical processes of light-induced polymer degradation. The UV absorbers have an extinction coefficient much higher than that of the polyester such that, most of the time UV light is absorbed by the UV absorbers rather than the polyester. The UV absorbers generally dissipate the absorbed energy as heat, thereby avoiding degradation of the polymer chain, and improving the stability of the polyester to UV light.

The concentration of the UV absorbers used is in the range of 0.1 to 5.0% by weight, preferably in the range from 0.5 to 3.0% by weight, based on the weight of input granules used for the production of the film.

Dip dyed films used in one of the embodiment are produced by dyeing of UV stabilized polyester film of a thickness is in the range of 12 μm to 250 μm. The process includes the steps of dyeing a UV stabilized polyester film in a bath comprising at least one dye and at least one polyhydric alcohol at a temperature above a glass transition temperature of the polyester film to obtain a dyed film, cleaning the dyed film by using a solvent, followed by mechanically scrubbing the cleaned film to remove undissolved particles from the film, and passing the cleaned and scrubbed film using a tenter device through an oven to produce a coloured polyester film having controlled shrinkage in the machine and transverse directions, with shrinkage of 0.4% to 8% in the machine direction and 0 to 10% in a transverse direction.

In an embodiment, the dip dyed films are produced by dyeing of hydrolysis resistant UV stabilized polyester film of a thickness is in the range of 12 μm to 250 μm.

The UV stabilized substrate layer used in the adhesive backed hydrolysis-resistant window film of the present disclosure comprises bi-axially oriented polyester film. The bi-axially oriented polyester film is a synergistic mixture of UV absorbers incorporated in the PET film matrices. The UV stabilized substrate layer used in the adhesive backed hydrolysis-resistant window film protects the glass and offers good weather resistance and very high absorption of UV radiation. In an embodiment, a UV absorber is added while production of UV stabilized PET substrate layer which reduces the UV transmission. The UV stabilized polyester substrate layer has high mechanical strength and good dimensional stability over a wide temperature range. The additional layer of UV stabilized substrate provides excellent mechanical properties, and stability towards UV induced decomposition of the polyester films. The thickness of the UV stabilized PET substrate layer used in the present disclosure can be in the range of 12μ to 200μ. In one embodiment, the thickness of the UV stabilized PET substrate layer is 23μ.

The adhesive backed hydrolysis-resistant window film are sometimes directly exposed to natural weathering conditions when installed on the outer surface of the automotive glass, outdoor weather attacks the polyester not only through UV radiation but also through hydrolysis, which cleaves the molecular chain of the polyester by chemical reaction with water. Therefore, at least one hydrolysis resistant polyethylene terephthalate substrate layer is specially UV stabilized to significantly lower the degradation process and hence is effective.

In an embodiment, wherein the release liner is a silicon polymeric layer.

In an embodiment, the scratch resistant coat comprises at least three polyfunctional acrylate derivatives, a photo-initiator, nanoscale filler, UV absorber, and combinations thereof.

In an embodiment, the scratch resistant coat (hard coat) is disposed on the first operative surface of the first substrate layer. The scratch resistant coat protects the film from scratching or other damage, such as from debris or impact. The thickness of the scratch resistant coat can be in the range of 2 gm/m² to 12 gm/m², preferably 3 to 6 gm/m². The scratch resistant coat can be formulated using a mixture of acrylic monomers, oligomers, photo-initiators, slip additive, rheology modifiers, and compatible solvents such as methyl ethyl ketone, isopropyl alcohol, toluene, or ethyl acetate. Acrylic monomers can be a mixture of bi, tri, tetra, penta, and hexa functional acrylates. Radiation curable hard coat with improved weatherability or abrasion resistance or a combination of weatherability and abrasion resistance provides protection to the underlying interlayers of the window film. The hard coat also contains UV absorbers to shield the film from sunlight, helping to prevent photodegradation and yellowing of hydrolysis resistant polyester films.

In an embodiment, the nanoscale filler (nanoparticles) is at least one selected from the group consisting of silica, zirconia, titania, ceria, alumina, antimony oxide, and zinc oxide.

The nanoscale filler of the present disclosure further comprises organic functional groups, such as acrylate functional groups. In an exemplary embodiment, the nanoscale filler is the acrylate functionalized silica. The acrylate functionalized silica can be produced by adding an acrylate functional alkoxysilane such as acryloxypropyl trimethoxysilane, methacryloxypropyl trimethoxysilane, acryloxypropyl triethoxysilane, or methacryloxypropyl triethoxysilane and mixtures thereof, to an aqueous silica colloid and heating the mixture to promote hydrolysis of the silane and condensation of silanol groups present on the silica nanoparticles with silanol groups or alkoxysilane groups of the acrylate functional silanes, and exchanging the aqueous phase with an organic phase by vacuum stripping. Replacement of the aqueous phase with the organic phase is necessary to allow the solution blend of the functionalized silica particles with the other coating components. Suitable materials for the organic phase may be acrylates or organic solvents with a boiling point higher than that of water.

The amount of nanoscale filler in the curable acrylate coating composition may be adjusted depending upon the desired usable life and the required property such as adhesion, abrasion resistance, good weather, and thermal crack resistance. The amount of nanoscale filler in the curable acrylate coating composition can be in the range of 1% to 65% based upon the total weight of the dry coating composition. In one preferred embodiment, the amount of nanoscale filler is in the range of 3% to 40%.

The acrylic monomers are low viscous materials, most commonly esters of acrylic acid and simple multifunctional or monofunctional polyols. Difunctional acrylates such as ethylene glycol diacrylate, propylene glycol diacrylate, butanediol diacrylate, pentanediol diacrylate, hexanediol diacrylate, heptanediol diacrylate, octanediol diacrylate, nonanediol diacrylate, decanediol diacrylate, glycerol 1,2-diacrylate, glycerol 1,3-diacrylate, pentaerythritol diacrylate, 2-hydroxy-3-acryloyloxypropyl methacrylate, tricyclodecane dimethanol diacrylate, dipropylene glycol diacrylate, and tripropylene glycol diacrylate; and Polyfunctional acrylates such as glycerol triacrylate, trimethylolpropane triacrylate, pentaerythritol triacrylate, dipentaerythritol triacrylate, ethoxylated isocyanuric acid triacrylate, ethoxylated glycerol triacrylate, ethoxylated trimethylolpropane triacrylate, pentaerythritol tetraacrylate, dipentaerythritol hexaacrylate, ditrimethylolpropane tetraacrylate, ethoxylated pentaerythritol tetraacrylate, trimethylolpropane trimethacrylate, and trispentaerythritol octaacrylate. The (meth) acrylates are effective for enhancing the function of the coating composition by reducing the cure time and imparting photo-curability and flexibility while maintaining the benefits of the composition of the present disclosure.

In an embodiment, the UV absorber is hydroxyphenyltriazine.

In UV curing technology, multifunctional resins are polymerized or cross-linked by exposure to UV light. The UV light triggers a UV photo initiator in the formulation to generate polymerization initiating species which very rapidly converts the liquid UV resins to a fully cross-linked coating. The UV hard coat composition contains photo polymerization initiators, commonly used in acrylic coating compositions. Suitable photopolymerization initiators include 1-hydroxy-cyclohexyl-phenyl-ketone; 2-Hydroxy-2-methyl-1-phenyl-1-propanone; alpha-dimethoxy-alpha-phenylacetophenone; 2-Benzyl-2-(dimethylamino)-1-[4-. (4-morpholinyl) phenyl]-1-butanone; Diphenyl (2,4,6-trimethylbenzoyl)-phosphine oxide; Phosphine oxide, phenyl bis (2,4,6-trimethyl benzoyl); and Bis (eta 5-2,4-cyclopentadien-1-yl) Bis [2,6-difluoro-3-(1H-pyrrol-1-yl) phenyl] titanium.

The amount of photopolymerization initiator used can be in the range of 0.1 to 20 parts, more preferably 1 to 15 parts, and even more preferably 3 to 10 parts by weight per 100 parts by weight of the total solid content of the composition.

Slip additives used in the preparation of scratch resistant coats can be colloidal silica nano particles and SiO₂ nanoparticles. The slip additive can be used, particularly when it is desired to enhance the hardness and resistance of a coating, an appropriate amount of colloidal silica may be added in the scratch resistant coat. It is a colloidal dispersion of nano-size silica having a particle size in the range of 5 to 50 nm in a medium such as water or organic solvent. In one embodiment, the commercially available water-dispersed or organic solvent-dispersed colloidal silica is used. The colloidal silica may be compounded in an amount of 0 to 10 parts, preferably 1 to 5 parts.

The scratch resistant coat can be applied on the hydrolysis resistant PET film surface using a gravure roll coater with a desired wet coating thickness, typically 2 to 8 g/m² dry coat weight. The scratch resistant coat protects the window film from scratching or other damage from impacting debris and from the wipers. The substrate provides structural integrity to the films and may provide some degree of dispersion impact.

Typically, organic solvents are used during the preparation of the scratch resistant coat. The organic solvent is at least one selected from the group consisting of aromatic hydrocarbons, such as benzene, toluene, and xylene; ketones such as acetone and methyl ethyl ketone; esters such as ethyl acetate and butyl acetate; and alcohols such as isopropyl alcohol. The amount of organic solvent is in the range of 10 to 90%, preferably in the range from about 40 to 60% with respect to the dry solids of the coating composition.

The scratch resistant coat is passed through a hot air circulated oven and UV curing equipment. The UV curing equipment may have microwave-powered lamps with variable power systems.

The adhesive backed hydrolysis-resistant window film of the present disclosure has a high visible light transmittance, a low infrared transmittance, and is capable of being applied to the glass in automotive and glass in architectural buildings, where long term mechanical durability is required.

In accordance with the present disclosure, the substrate is a thick layer of bi-axially oriented polyester film. The polyester film used in the present disclosure is partially crystalline, having a low haze value, preferably below 2.0%, and has a visible light transmittance above 86%. The polyester film has excellent optical clarity, mechanical properties, and stability towards thermal aging. The thickness of the polyester film used in the present disclosure is in the range of 12 μm to 300 μm, preferably in the range of 23 μm to 190 μm. The polyester films used in the window film of the present disclosure have a tensile strength in the range of 1000 to 3000 Kg/cm².

Typically, the adhesive backed hydrolysis-resistant window film of the present disclosure is optically clear and distortion free. A basic requirement of the window film is sufficient flexibility and shrink ability for installation on curved glass. PET films used in the preparation of the adhesive backed hydrolysis-resistant window film can be produced using a synergistic mixture of additives such as antioxidant, thermal stabilizers, and HAL (Hindered-Amine Light) stabilizer and hydrolysis resistance additives.

The hydrolysis resistant film further comprises additives such as anti-oxidant. In one embodiment a range of antioxidants, which work by trapping radicals or by decomposing peroxide, may be used. Suitable radical-trapping antioxidants can be selected from the group consisting of hindered phenols, secondary aromatic amines, and hindered amines. Suitable peroxide-decomposing antioxidants can be selected from the group consisting of trivalent phosphorous compounds, such as phosphonites, phosphites (e.g. triphenyl phosphate and trialkylphosphites), and thiosynergists (e.g. esters of thiodipropionic acids such as dilauryl thiodipropionate). In one embodiment, the antioxidant is hindered phenol, such as tetrakis-(methylene 3-(4′-hydroxy-3′, 5′-di-t-butylphenyl propionate) methane; pentaerythritol Tetrakis(3-(3,5-di-tert-butyl-4-hydroxyphenyl)propionate); octadecyl-3-(3,5-di-tert.butyl-4-hydroxyphenyl)-propionate; Ethylene bis (oxyethylene) bis(3-tert-butyl-4-hydroxy-5(methylhydrocinnamate); N,N′-Hexamethylene-bis (3,5-di-tert-butyl-4-hydroxyhyrocinnamamide); 3,5-Di-tert-butyl-4-hydroxyhydrocinnamic acid, C7-9 125643-61-0 branched alkyl esters; and bis-(1-Octyloxy-2,2,6,6,tetramethyl-4-piperidinyl) sebacate.

The concentration of the antioxidant present in the polyester film can be in the range from 50 ppm to 5000 ppm, preferably in the range of 300 ppm to 1200 ppm, more preferably in the range from 450 ppm to 600 ppm.

The adhesive backed hydrolysis-resistant window film of the present disclosure has infrared shielding ability. Further, it has excellent mechanical properties and exterior durability.

The adhesive backed hydrolysis-resistant window film of the present disclosure is installed on interior or exterior surfaces of pre-cleaned window glasses which protect the surface of Glass. The adhesive backed hydrolysis-resistant window film provides protection against injurious flying splinters in the event of explosions, accidents, and natural disasters. These films hold the broken pieces of glasses and remain in the frame. The window film is flexible so that the films can be molded to a curved glass surface.

The foregoing description of the embodiments has been provided for purposes of illustration and not intended to limit the scope of the present disclosure. Individual components of a particular embodiment are generally not limited to that particular embodiment, but, are interchangeable. Such variations are not to be regarded as a departure from the present disclosure, and all such modifications are considered to be within the scope of the present disclosure.

The present disclosure is further described in light of the following experiments which are set forth for illustration purpose only and not to be construed for limiting the scope of the disclosure. The following experiments can be scaled up to industrial/commercial scale and the results obtained can be extrapolated to industrial scale.

### EXPERIMENTAL DETAILS

### Experiment-1: Adhesive Backed Hydrolysis-Resistant Window Film in Accordance with the Present Disclosure

An adhesive backed hydrolysis-resistant window film was prepared by using 100μ clear bi-axially oriented hydrolysis resistant polyethylene terephthalate substrate layer (HRPET). The HRPET was produced and supplied by Garware Hi-Tech Films Ltd under the trade name GARFILM, with excellent optical clarity, mechanical properties, and outdoor stability. Various layers used in the adhesive backed hydrolysis-resistant window film are listed in Table-1.

TABLE 1
Details of the layers of the adhesive backed hydrolysis-resistant
window film in accordance with the present disclosure:

Acrylic based scratch resistant layer + IR NANO
Hydrolysis resistant PET substrate layer − 100μ
Polyurethane based adhesion promotion layer
Acrylic based adhesive Layer
Silicon release liner

Infrared Absorbing acrylic base hard coat layer was formed on a first operative surface of the hydrolysis resistant polyethylene terephthalate substrate layer (HRPET) by applying a mixture of CTO Nano-dispersion and UV curable acrylic resin formulation using a gravure roll coater to achieve a coat weight of 3 to 6 grams per meter square to obtain a coated layer. The so obtained coated layer was passed through a hot air circulating oven and UV curing equipment. The UV curing equipment contained microwave-powered lamps with variable power systems manufactured by Fusion UV Inc. USA.

A polyurethane based adhesion promotion layer was formed on a second operative surface of the hydrolysis resistant PET substrate layer. A solvent based acrylic pressure sensitive adhesive was coated on the adhesion promotion layer surface to obtain an adhesive coated layer. The so obtained adhesive coated layer was passed through a hot air circulated oven to splash off the solvent and to cure the second film followed by disposing a silicon release liner on the surface of the adhesive coated layer to obtain the window film.

### Experiment 1a

An adhesive backed hydrolysis-resistant window film was prepared in a similar manner as described in experiment 1, except that the thickness of the hydrolysis resistant polyethylene terephthalate polyester substrate layer was 36μ obtained from Garware Hi-Tech Films Ltd.

### Experiment 1b

An adhesive backed hydrolysis-resistant window film was prepared in a similar manner as described in experiment 1, except that the PET substrate layer had a thickness of 100μ and was not hydrolysis resistant & scratch resistant layer without IR Nano dispersion.

### Experiment 1c

An adhesive backed hydrolysis-resistant window film was prepared in a similar manner as described in experiment 1, except that the PET substrate layer had a thickness of 36μ and was not hydrolysis resistant & scratch resistant layer without IR Nano dispersion.

### Experiment-2: An Adhesive Backed Hydrolysis-Resistant Window Film in Accordance with the Present Disclosure

An adhesive backed hydrolysis-resistant window film was prepared using a UV stabilized PET substrate layer co-extruded with the hydrolysis resistant polyethylene terephthalate substrate layer (Coex-HRPET) having a thickness of 190μ. The Coex-HRPET was produced and supplied by Garware Hi-Tech Films Ltd under the trade name GARFILM. The co-extruded UV stabilized hydrolysis resistant polyethylene terephthalate substrate layer had excellent optical clarity, mechanical properties, and outdoor weathering properties. Various layers used in the adhesive backed hydrolysis-resistant window film are listed in Table-2.

TABLE 2
Details of the layers of the adhesive backed hydrolysis-resistant
window film in accordance with the present disclosure.

Acrylic based scratch resistant coat + IR Nano
Co-extruded UV stabilized + hydrolysis resistant PET substrate
layer − 190μ
Polyurethane based adhesion promotion layer.
Acrylic based adhesive layer
Silicon release liner

Infrared absorbing acrylic based hard coat layer was formed on a first operative surface of the UV Stabilized hydrolysis resistant co-extruded polyethylene terephthalate polyester substrate layer (Coex-HRPET). The scratch resistant coat was formed by applying a mixture of nano dispersion and UV curable acrylic resin formulation using a gravure roll coater to achieve a coat weight of 3 to 6 grams per meter square to obtain a coated layer. Further, the so obtained coated layer was passed through a hot air circulating oven and UV curing equipment. The UV curing equipment contained microwave-powered lamps with Variable Power Systems from Fusion UV Inc. USA. The maximum output at 100% power level was 600 watts/inch (240 watts/cm).

A polyurethane based adhesion promotion layer was formed on a second operative surface of the Coex-HRPET. A solvent based acrylic pressure sensitive adhesive was coated on the adhesion promotion layer surface to obtain an adhesive coated layer. The so obtained adhesive coated layer was passed through a hot air circulated oven to splash off the solvent and to cure the film followed by disposing silicon release liner on the surface of the solvent based acrylic pressure sensitive adhesive layer to obtain the adhesive backed hydrolysis-resistant window film.

### Experiment 2a

An adhesive backed hydrolysis-resistant window film was prepared in a similar manner as described in experiment 2, except that the PET substrate layer had a thickness of 190μ and the PET substrate layer was not hydrolysis resistant & scratch resistant layer without IR Nano dispersion.

### Experiment-3: Adhesive Backed Hydrolysis-Resistant Window Film in Accordance with the Present Disclosure

An adhesive backed hydrolysis-resistant window film was prepared using a 100μ hydrolysis resistant polyethylene terephthalate substrate layer (HRPET) produced and supplied by Garware Hi-Tech Films Ltd. under the trade name GARFILM. Various layers used in the adhesive backed hydrolysis-resistant window film are listed in Table-3.

TABLE 3
Details of the layers of the adhesive backed hydrolysis-resistant
window film in accordance with the present disclosure

Silicon scratch resistant coat with improved weatherability + IR Nano
Hydrolysis resistant PET substrate layer − 100μ
Polyurethane based adhesion promotion layer
Acrylic based adhesive layer
Silicon release liner

Infrared absorbing silicon base hard coat layer having improved weatherability was formed on a first operative surface of the hydrolysis resistant polyethylene terephthalate polyester substrate layer (HRPET) by applying a mixture of CTO Nano dispersion and UV curable silicon base resin UVSC 3000 supplied by Momentive Performance Materials Inc. using a gravure roll coater to achieve a coat weight of 3 to 10 grams per meter square to obtain a coated layer. Further, the so obtained coated layer was passed through a hot air circulating oven and UV curing equipment. The UV curing equipment contained microwave-powered lamps with Variable Power Systems from Fusion UV Inc. USA.

An adhesion promotion layer was formed on a second operative surface of the hydrolysis resistant PET substrate layer. A solvent-based acrylic pressure sensitive adhesive layer was coated on the adhesion promotion layer surface to obtain an adhesive coated layer. The so obtained adhesive coated layer was passed through the hot air circulated oven to splash off the solvent and to cure the film followed by disposing of a silicon release layer on the surface of the adhesive coated layer to obtain the adhesive backed hydrolysis-resistant window film.

### Experiment 3a

An adhesive backed hydrolysis-resistant window film was prepared in a similar manner as described in experiment 3, except that the substrate was a 100p PET was not hydrolysis resistant polyethylene terephthalate polyester substrate layer.

### Experiment-4: Adhesive Backed Hydrolysis-Resistant Window Film in Accordance with the Present Disclosure

An adhesive backed hydrolysis-resistant window film was prepared using a 23μ HS (Hydrolysis stabilized) Stabilized PET film layer and 36p UV stabilized hydrolysis resistant PET substrate layer. A thermosetting adhesive was mixed with near-infrared absorbing nanoparticles was disposed between the second operative surface of a UV stabilized hydrolysis resistant PET substrate layer and the first operative surface of HS Stabilized PET film layer. Various layers used in the adhesive backed hydrolysis-resistant window film are summarized in Table-4.

TABLE 4
Details of the layers of the adhesive backed hydrolysis-resistant
window film in accordance with the present disclosure

Acrylic based scratch resistant coat
UV stabilized hydrolysis resistant PET substrate layer − 36μ
Thermosetting adhesive layer + IR Nano
HS stabilized PET substrate layer − 23μ
Adhesive layer
Silicon release liner

An acrylic based scratch resistant layer was formed on the first operative surface of the UV stabilized hydrolysis resistant polyethylene terephthalate substrate layer (HRPET).

The scratch resistant layer was formed on the first operative surface of the UV stabilized hydrolysis resistant polyethylene terephthalate polyester substrate layer (HRPET) by applying a UV Curable acrylic resin formulation using a gravure roll coater to achieve a coat weight of 3 to 15 grams per meter square to obtain a coated layer. Further, the so obtained coated layer was passed through a hot air circulating oven and UV curing equipment. The UV curing equipment contained microwave-powered lamps with Variable Power Systems manufactured by Fusion UV Inc. USA.

A solvent based acrylic pressure sensitive adhesive layer was coated on a second operative surface of the HS Stabilized PET substrate layer to obtain an adhesive coated layer. The so obtained adhesive coated layer was passed through the hot air circulated oven to splash off the solvent and to cure the film followed by disposing of a silicon release layer on the surface of the adhesive coated layer to obtain the adhesive backed hydrolysis-resistant window film.

### Experiment 4a

An adhesive backed hydrolysis-resistant window film was prepared in a similar manner as described in experiment 4, except that the substrate was a 36p polyethylene terephthalate polyester substrate layer.

### Experiment-5: Adhesive Backed Hydrolysis-Resistant Window Film in Accordance with the Present Disclosure

An adhesive backed hydrolysis resistant window film was prepared by laminating a 36μ hydrolysis resistant polyethylene terephthalate substrate layer (HRPET) and a 23μ dip dyed PET film layer supplied by Garware Hi-Tech Films Ltd produced as per the method described in U.S. Pat. No. 6,316,531 “Process for dyeing UV stabilized polyester film”

Various layers used in the adhesive backed hydrolysis-resistant window film are summarized in Table-5.

TABLE 5
Details of the layers of the adhesive backed hydrolysis-resistant
window film in accordance with the present disclosure

Improved silicon based scratch resistant coat
Hydrolysis resistant PET substrate layer − 36μ
Thermosetting adhesive layer + NANO Dispersion
Dip dyed PET film layer 23μ
Polyurethane based adhesion promotion layer.
Acrylic based adhesive Layer
Silicon Release Liner

A thermosetting adhesive was mixed with near infrared absorbing nano particles and a layer was formed between a second operative surface of the 50μ HRPET substrate layer and a first operative surface of the 50p PET substrate layer.

A scratch resistant coat with improved weatherability was formed on the first operative surface of the hydrolysis resistant polyethylene terephthalate substrate layer (HRPET) by applying a UV curable silicon base resin UVSC 3000 supplied by Momentive Performance Materials Inc., using a gravure roll coater to obtain a coated layer. Further, the so obtained coated layer was passed through a hot air circulating oven and UV curing equipment. The UV curing equipment contained microwave-powered lamps with Variable Power Systems manufactured by Fusion UV Inc. USA. The Maximum output at 100% power level was 600 watts/inch (240 watts/cm).

A polyurethane based adhesion promotion layer was formed on a second operative surface of the dip dyed PET film layer 23μ. A solvent based acrylic pressure sensitive adhesive layer was formed on the polyurethane based adhesion promotion layer surface to obtain an adhesive coated layer. The so obtained adhesive coated layer was passed through a hot air circulated oven to splash off the solvent and to cure the adhesive coated layer, followed by disposing a silicon release liner on the surface of the solvent based acrylic pressure sensitive adhesive layer to obtain the adhesive backed hydrolysis-resistant window film.

### Experiment 5a

An adhesive backed hydrolysis-resistant window film was prepared in a similar manner as described in experiment 5, except that the 23p Metallized polyethylene terephthalate polyester substrate layer was used instead of dyed film.

Near infra-red absorbing nano-particles incorporated in the thermosetting adhesive layer absorbs the infra-red radiations from 700 nm to 2500 nm. The infrared shielding/absorption window film has a high visible light transmittance and a low infrared transmittance.

The adhesive backed hydrolysis-resistant window film of the present disclosure is capable of being applied to the front side & side windows of the vehicle where long-term retention of mechanical properties is desired. The use of a hard coat/scratch resistant coat with a silicon backbone further improves the optical clarity for long-term exposure to natural weathering conditions.

UV-VIS-NIR spectrum demonstrates the ability of NIR blocking property of the adhesive backed hydrolysis-resistant window film as illustrated in FIG. 1.

### Experiment-6: Pressure Cooker Test

The pressure cooker test wherein controlled conditions of high temperature, high pressure, and high relative humidity was provided for accelerated conditions of aging, to evaluate the adhesive backed hydrolysis-resistant window film.

The adhesive backed hydrolysis-resistant window film obtained in Experiments 1 to 5 and respective comparative experiments, i.e. 1, 1a, 1b, 1c, 2, 2a, 3, 3a, 4, 4a, 5, and 5a were cut in 15 mm width and length 150 mm. and laminated on 6 mm thick clear float glass using standard techniques. The adhesive backed hydrolysis-resistant window film was allowed to cure at ambient temperature and relative humidity below 50% for 10 days.

These samples were kept in a pressure cooker at a pressure of 1.0 kg/cm² and a temperature of 121° C. The mechanical properties (tensile strength) relating to the aging of the adhesive backed hydrolysis-resistant window film were then measured at various time intervals.

Tensile strength test was conducted in accordance with ASTM D882 at a jaw separation rate of 300 mm/min using 15 mm width samples and averaging the results of at least 5 specimens. Each sample was tested using an Instron model no 4411H material test machine, using mechanical grips with rubber jaw faces at a temperature of 23° C. and relative humidity of 50%.

The samples were removed at regular intervals i.e. 48 hours and 72 hours and the tensile strength was evaluated. Test results are compared against the unexposed samples and samples subjected to the pressure cooker test are summarized in Table-6.

TABLE-6
Pressure cooker test (PCT)

| | % Tensile strength retention | | |
|---|---|---|---|
| Examples | Initial 0 hrs | 48 Hrs | 72 Hrs |
| Experiment -1 | 100 | 65.9 | 57.5 |
| Experiment - 1a | 100 | 65.1 | 57.9 |
| Experiment - 1b | 100 | 47 | Brittle |
| Experiment - 1c | 100 | 30 | Brittle |
| Experiment - 2 | 100 | 83 | 49 |
| Experiment 2a | 100 | 41 | Brittle |
| Experiment - 3 | 100 | 75 | 62 |
| Experiment 3a | 100 | 29 | Brittle |
| Experiment - 4 | 100 | 79 | 45 |
| Experiment - 4a | 100 | 39 | Brittle |
| Experiment - 5 | 100 | 76 | 48 |
| Experiment - 5a | 100 | 70 | 40 |

It is evident from Table 6 that the tensile strength retention is excellent in the films produced using the hydrolysis resistant polyethylene terephthalate substrate layer (HRPET), whereas the films are brittle where hydrolysis resistant polyethylene terephthalate polyester substrate layer was not used (after 72 hours of exposure). The use of a hydrolysis resistance substrate layer provides extended mechanical property retention when exposed to harsh environmental conditions. Therefore, the window film of the present disclosure has excellent moisture resistance and durability.

### Experiment-7: Accelerated Weathering Test

The artificial accelerated weathering tests are performed to evaluate the long-term stability of the film on prolonged exposure to natural weather conditions. The films are evaluated to observe whether micro-cracks develop on the exterior surface of the UV Hard coat and whether colour fades over a period of time due to exposure to sunlight. The films of the present disclosure were exposed to accelerated weathering and compared to known controls and existing known window film.

UV TEST (Atlas Make)

The UV test was conducted to assess the cracking behaviour of the UV hard coats. The hard coat side of the film was exposed to the UV lamp side. The weathering cycle consisted of 8 hours exposure to UV light with UV-A fluorescent lamps at 60° C. and 4 hours exposure to condensed moisture cycle in the dark at 50° C., and irradiance at 0.89 W/m² @ 340 nm. The exposed samples were checked at various stages and observed for microcracking on the UV hard coated surface in UV test accelerated weathering tester in accordance with ASTM G154 Cycle 1. The microcracking of the film was considered as the endpoint of the test. The results obtained are summarized in Table-7.

TABLE-7
Cracking observations/results after UV TEST
UV (accelerated weathering) Test Report

| | QUV Direct Exposure test. |
|---|---|
| Experiments | Cracks Observation |
| Experiment - 1 | Observed at 1406 hrs. |
| Experiment - 1a | Observed at 1455 hrs. |
| Experiment - 1b | Observed at 660 hrs. |
| Experiment - 1c | Observed at 780 hrs. |
| Experiment - 2 | Observed at 1430 hrs. |
| Experiment - 2a | Observed at 803 hrs. |
| Experiment - 3 | Observed after 2500 hrs. |
| Experiment - 3a | Observed after 2400 hrs. |
| Experiment - 4 | Observed after 770 hrs. |
| Experiment - 4a | Observed after 700 hrs. |
| Experiment - 5 | Observed after 2244 hrs. |
| Experiment - 5a | Observed after 2340 hrs. |

The test results demonstrate that acrylic based UV curable hard coats in combination with NIR blocking nano particles delays development of microcracks when exposed to accelerated weathering test.

The test results demonstrate that the microcracks are developed in acrylic base UV curable hard coats after exposure to natural weathering conditions, whereas the use of hard coats with silicon backbone extends the life of the window film.

The infra-red absorbing/shielding window film has a high visible light transmittance and a low infrared transmittance. Therefore, it is observed that the window film of the present disclosure is capable of being applied to the exterior side of architectural buildings and automobiles where long-term retention of mechanical properties is desired.

Accelerated testing of the window film resulted in degradation of the UV hard coat and micro-cracking on the outer surface of the window film. The use of silicon backbone delays the degradation of the hard coat provided on the outer surface of window film.

Technical Advancements

The present disclosure described hereinabove has several technical advantages including, but not limited to, the realization of an adhesive backed hydrolysis-resistant window film that:
has high visible light transmittance;
has low infrared transmittance;
has long term mechanical durability;
improved weatherability;
improved infrared shielding ability;
is scratch resistant; and
has long-term UV stability and hydrolysis resistance.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the invention to achieve one or more of the desired objects or results. While certain embodiments of the inventions have been described, these embodiments have been presented by way of example only, and are not intended to limit the scope of the inventions. Variations or modifications to the formulation of this invention, within the scope of the invention, may occur to those skilled in the art upon reviewing the disclosure herein. Such variations or modifications are well within the spirit of this invention.

The numerical values given for various physical parameters, dimensions, and quantities are only approximate values and it is envisaged that the values higher than the numerical value assigned to the physical parameters, dimensions and quantities fall within the scope of the invention unless there is a statement in the specification to the contrary.

While considerable emphasis has been placed herein on the specific features of the preferred embodiment, it will be appreciated that many additional features can be added and that many changes can be made in the preferred embodiment without departing from the principles of the disclosure. These and other changes in the preferred embodiment of the disclosure will be apparent to those skilled in the art from the disclosure herein, whereby it is to be distinctly understood that the foregoing descriptive matter is to be interpreted merely as illustrative of the disclosure and not as a limitation.

1. An adhesive backed hydrolysis-resistant window film comprising:
at least one hydrolysis resistant polyethylene terephthalate (PET) first substrate layer having a first operative surface and a second operative surface;
a NIR absorbing scratch resistant coat having near-infrared absorbing nano-particles disposed on said first operative surface;
optionally at least one hydrolysis resistant polyethylene terephthalate (PET) second substrate layer having a third operative surface and a fourth operative surface;
a first adhesive layer disposed on said second operative surface and optionally on said fourth operative surface;
optionally a second adhesive layer containing infrared absorbing nano-particles disposed between said second operative surface and said third operative surface;
at least one release liner disposed on said first adhesive layer; and optionally an adhesion promoter layer disposed above said first adhesive layer.

2. The film as claimed in claim 1,
a. wherein said hydrolysis resistant polyethylene terephthalate (PET) first substrate layer comprises at least one hydrolysis resistant stabilizer and optionally said hydrolysis resistant polyethylene terephthalate (PET) second substrate layer comprises at least one hydrolysis resistant stabilizer; and
b. wherein said hydrolysis resistant polyethylene terephthalate (PET) first substrate layer is UV stabilized hydrolysis resistance polyethylene terephthalate substrate layer, and wherein said UV stabilized hydrolysis resistance polyethylene terephthalate first substrate layer comprises at least one hydrolysis resistant stabilizer.

3. The film as claimed in claim 1, wherein said hydrolysis resistant polyethylene terephthalate (PET) second substrate is at least one selected from UV stabilized dip dyed polyethylene terephthalate (PET) substrate and dip dyed polyethylene terephthalate (PET) substrate.

4. The film as claimed in claim 1, wherein said first substrate layer is co-extruded with said second substrate layer.

5. The film as claimed in claim 1, wherein said infrared absorbing nanoparticle is at least one selected from the group consisting of composite tungsten oxide particles, hexaboride nanoparticles, antimony tin oxide (ATO), and indium tin oxide (ITO) nanoparticles.

6. The film as claimed in claim 5, wherein said composite tungsten oxide particle is represented by the formula MxWyOz, wherein M is at least one metal selected from the group consisting of alkali metals, alkali earth metals, a rare earth element, and one or more elements selected from the group consisting of Mg, Zr, Cr, Mn, Fe, Ru, Co, Rh, Ir, Ni, Pd, Pt, Cu, Ag, Au, Zn, Cd, Al, Ga, In, TI, Si, Ge, Sn, Pb, Sb, B, F, P, S, Se, Br, Te, Ti, Nb, V, Mo, Ta, Re, Be, Hf, Os, and Bi; W is tungsten, O is oxygen, wherein x is ≥0.001, y is ≤1 and z is in the range of 2.2 to 3.0.

7. The film as claimed in claim 1, wherein said scratch resistant coat is at least one selected from the group consisting of silicon based UV hard coat and acrylic based UV hard coat.

8. The film as claimed in claim 1, wherein said first adhesive layer and said second adhesive layer are independently selected from the group consisting of polyurethane adhesives, silylated polyurethane adhesives, and pressure sensitive adhesives.

9. The film as claimed in claim 1, wherein said adhesion promoter layer is at least one selected from the group consisting of polyurethanes and acrylates.

10. The film as claimed in claim 2, wherein said hydrolysis resistant stabilizer is selected from the group consisting of carbodiimide compound and glycidyl ester of branched mono-carboxylic acid.

11. The film as claimed in claim 10, wherein said carbodiimide compound is at least one selected from the group consisting of dicyclohexyl carbodiimide, diisopropyl carbodiimide, di-isobutyl carbodiimide, dioctyl carbodiimide, octyl decyl carbodiimide, dibenzyl carbodiimide, diphenyl carbodiimide, N-benzyl-N-phenyl carbodiimide, di-p-toluyl carbodiimide, bis(2,6 di isopropyl phenyl)carbodiimide and 2,6,2′, 6′-tetra isopropyl diphenyl carbodiimide, wherein an amount of said carbodiimide compound is in the range of 1 to 10 parts by weight of the polyester film.

12. The film as claimed in claim 10, wherein a carbon atom count of said glycidyl ester of branched monocarboxylic acid is in the range of 5 to 50 carbon atoms.

13. The film as claimed in claim 2, wherein said UV stabilized hydrolysis resistance polyethylene terephthalate layer comprises at least one UV absorber selected from the group consisting of 2-hydroxybenzophenones, 2-hydroxybenzotriazoles, organonickel compounds, salicylic esters, cinnamic ester derivatives, resorcinol monobenzoates, oxanilides, hydroxybenzoic esters, benzoxazinones, sterically hindered amines, triazines, hydroxyphenyltriazine, and hydroxyphenyl-benzotriazole triazines.

14. The film as claimed in claim 1, wherein said release liner is a silicon polymeric layer.

15. The film as claimed in claim 1, wherein said scratch resistant coat comprises radiation curable hard coat coating composition comprising at least three polyfunctional acrylate derivatives, a photo-initiator, nanoscale filler, slip additive, UV absorber, and combinations thereof.

16. The film as claimed in claim 15, wherein said nanoscale filler is at least one selected from the group consisting of silica, zirconia, titania, ceria, alumina, antimony oxide, and zinc oxide.

17. The film as claimed in claim 15, wherein said nanoscale filler is acrylate functionalized silica.

18. The film as claimed in claim 15, wherein said slip additive is at least one selected from the group consisting of colloidal silica nanoparticles and SiO₂ nanoparticles.

19. The film as claimed in claim 15, wherein said photo-initiator is at least one selected from the group consisting of 1-hydroxy-cyclohexyl-phenyl-ketone, 2-Hydroxy-2-methyl-1-phenyl-1-propanone, alpha-dimethoxy-alpha-phenylacetophenone, 2-Benzyl-2-(dimethylamino)-1-[4-(4-morpholinyl) phenyl]-1-butanone, Diphenyl (2,4,6-trimethylbenzoyl)-phosphine oxide, Phosphine oxide, phenyl bis (2,4,6-trimethyl benzoyl), and Bis (eta 5-2,4-cyclopentadien-1-yl) Bis [2,6-difluoro-3-(1H-pyrrol-1-yl) phenyl] titanium.

20. The film as claimed in claim 15, wherein said UV absorber is hydroxyphenyltriazine.
